(19) United States
(12) Patent Application Publication
(10) Pub. No.: US 2010/0056113 A1
(43) Pub. Date: Mar. 4, 2010

(54) Location-Aware Voicemail

(75) Inventor: Alexander E. Silverman, Mercer Island, WA (US)

Correspondence Address: AT&T Legal Department - WW, Patent Docketing Room 2A-207, One AT&T Way, Bedminster, NJ, 07921, US

(73) Assignee: AT&T MOBILITY II LLC, Atlanta, GA (US)

(21) Appl. No.: 12/198,769

(22) Filed: Aug. 26, 2008

(51) Int. Cl. H04M 11/10; H04W 24/00

(52) U.S. Cl. 455/413; 455/456.3

(57) ABSTRACT

Location-aware voicemail that utilizes location information is described herein. When a voicemail service is initiated, location information may be used to provide additional information and functionality. In one example, location information about the caller that left a voicemail may be affixed to a voicemail message. When a recipient of the voicemail checks for voicemail messages, the recipient may be presented with various displays that utilize the location of the caller. In another example, location information about the intended recipient of a voicemail may be used by the caller to determine if the caller continues to desire to leave a voicemail. Privacy settings may be used to limit the amount of location information presented. Further, the location information may be used to provide for filters to sort one or more voicemails according to a location.

### BACKGROUND

Current voicemail systems provide certain information to the recipient of the voicemail. Some of the information may include the time that the voicemail was left, the caller's number, the identification of the caller (if available), and the length of the voicemail. This information, usually determined at the time the caller leaves the voicemail, may be presented to the recipient of the voicemail in several presentation types. Some presentation types include, but are not limited to, text, text-to-speech, and graphical display. The information provided to the recipient has limited use. Further, the information provided to the caller who left the voicemail is typically limited to audible instructions for leaving a voicemail and various additional options. Thus, current voicemail systems provide limited information to either the recipient of the voicemail or a caller that left the voicemail, or both.

### SUMMARY

A voicemail message having a data portion and location information of a caller is provided to the recipient of the voicemail message or the like. In one example, the data portion may be an audio recording of a caller attempting to contact an intended recipient of the data portion. In another example, the data portion may be text derived from an audio recording. When a data portion is created, the location information of the caller providing the data portion is determined. The location information is affixed in various ways to an optional message header and the data portion to create a voicemail message. Examples of ways in which the location information may be affixed include, but are not limited to, appending the location information to the data portion, prepending the location information to the data portion, interleaving the location information with the data portion, or embedding the location information within the data portion while still maintaining the location information distinct from the data portion.

The location information may be determined using various technologies including, but not limited to, assisted global positioning (“AGPS”), Global Positioning System, (“GPS”), and time delay of arrival (“TDOA”). The location information may be presented to the recipient of the voicemail message in several display types. For example, the location information may be affixed to a text message, may be affixed to a text-to-speech, may be added in a graphical display, or may be presented in a map. Thus, when a caller receives a voicemail message, the voicemail message may include location information.

Further, settings may be established to present or display the location information, or the voicemail message, in a manner determined by a determined location. For example, if a determined location is a certain distance away from an inputted or specified location, the location information or the voicemail message may be presented, inter alia, by placing the voicemail message at the beginning of a voicemail message queue or by displaying the voicemail message in a certain color to connote a possible issue. Additional privacy settings may be provided to the recipient of the voicemail message or the caller of the voicemail message to reduce or eliminate the determination of location information. The privacy settings may be permanent or may vary according to specified privacy conditions. Exemplary specified conditions may include, but are not limited to: the location of the caller, the location of the recipient, the time the call was placed, and the relative location between two specified points, such as the distance between the caller and the recipient at the time the voicemail message was generated.

Additionally, location information may be provided to the caller that left the voicemail message. For example, when attempting to leave a voicemail message, the caller may be asked if the caller would like to receive location information about the person who the caller is attempting to contact. The location information may be determined in a manner similar to how the caller's location information was determined and may be presented via a similar type of display. Further, privacy settings may also be established for the recipient of the voicemail message, whereby the recipient, or other party, may be able to block the determination and/or dissemination of location information about the recipient to the caller. The privacy settings may be permanent or may vary according to specified privacy conditions. Exemplary specified conditions may include, but are not limited to: the location of the caller, the location of the recipient, the time the call was placed, and the relative location between two specified points, such as the distance between the caller and the recipient at the time the voicemail message was generated.

### BRIEF DESCRIPTION OF THE DRAWINGS

The foregoing and other aspects of location-aware voicemail will be better understood from the following detailed description with reference to the drawings.

FIG. 1 is an illustration of an exemplary and non-limiting simplified example of a system for providing location-aware voicemail;

FIG. 2 is an illustration of an exemplary and non-limiting example of a data structure of a location-aware voicemail message having location information;

FIG. 3 is an illustration of an exemplary and non-limiting example of an alternative data structure of a location-aware voicemail message having location information;

FIG. 4 is an illustration of an exemplary and non-limiting example of a further alternative data structure of a location-aware voicemail message having location information;

FIG. 5 is an illustration of an exemplary and non-limiting example of embedding location information using steganographic techniques;

FIG. 6 is an illustration of an exemplary and non-limiting example of a mobile device display of a location-aware voicemail message having location information;

FIG. 7 is an illustration of an exemplary and non-limiting example of a mobile device display of multiple location-aware voicemail messages having location information;

FIG. 8 is an illustration of an exemplary and non-limiting example of a mobile device display of location information associated with a location-aware voicemail on a map;

FIG. 9 is an illustration of an exemplary and non-limiting example of a mobile device display of a location-aware voicemail on a map in relation to a location;

FIG. 10 is a flow diagram of an exemplary and non-limiting process for providing location-aware voicemail;

FIG. 11 is a flow diagram of an exemplary location-aware voicemail process using privacy settings;

FIG. 12 is a flow diagram of an exemplary location-aware voicemail process in which recipient location information is provided to the caller;

FIG. 13 is a flow diagram of an exemplary location-aware voicemail process in which a filter is used to determine how a voicemail message is delivered;

FIG. 14 is a block diagram of an example processor for generating and/or determining and transmitting and/or receiving location information in conjunction with location-aware voicemail; and

FIG. 15 illustrates a typical GPRS network architecture of as segmented into four groups.

### DETAILED DESCRIPTION OF ILLUSTRATIVE EMBODIMENTS

The subject matter of the various embodiments is described with specificity to meet statutory requirements. However, the description itself is not intended to limit the scope of this patent. Rather, the inventor has contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly required. It should be understood that the explanations illustrating data or signal flows are only exemplary. The following description is illustrative and non-limiting to any one aspect.

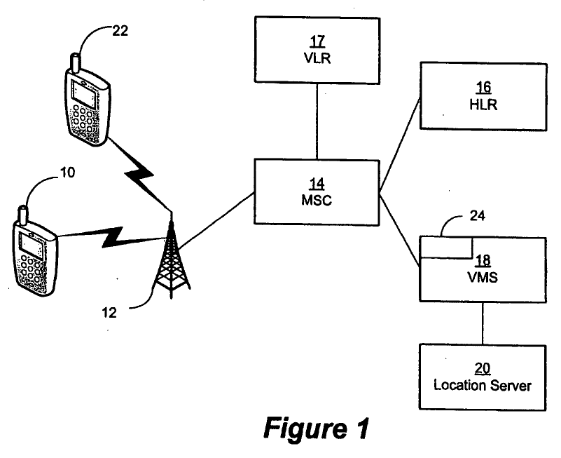

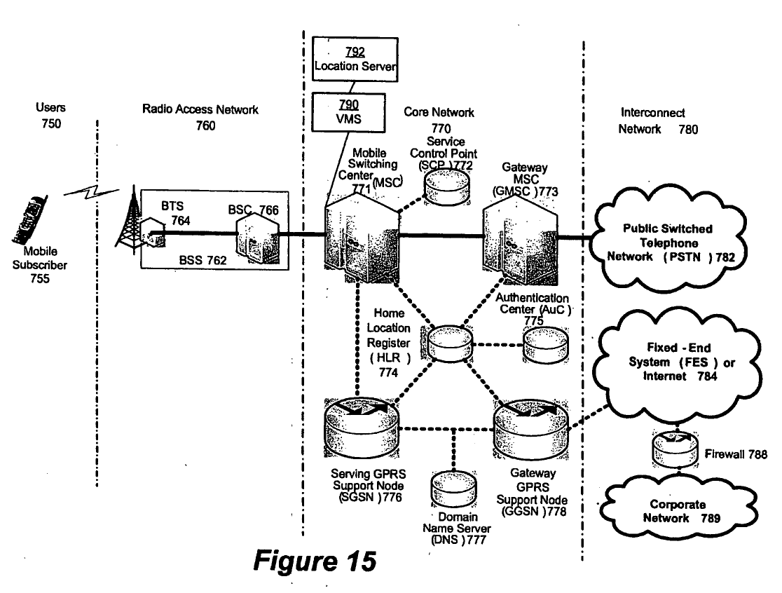

Further, the term “location” may be used in various, non-limiting contexts. For example, the present subject matter may use “location” as used in the context of a Home Location Register (“HLR”), such as HLR 774, as illustrated in FIG. 15, or Visitor Location Register (“VLR”), as illustrated in FIG. 1. The present subject matter may also use “location” when describing a geographic location. It should be noted that the “location” of one or more devices which is affixed to a voicemail, as described below, may be determined using various known systems, such as GPS or TDOA. The present subject matter is not limited to any particular way in which location information may be determined or to any specific communication system in which a location may be determined. Location as it pertains to landline telephones may be determined based on NPA-NXX designations, latitude-longitude address tables, or other methods known by those skilled in the art.

Current voicemail systems typically provide only a telephone number, the name of a person leaving a voicemail message, and time of leaving the voicemail message. By using other information that may be available about the caller and/or intended recipient of the voicemail such as the location of either the caller or the intended recipient, much more useful information may be provided to a caller. In one non-limiting embodiment of the present subject matter, when a recipient uses a voicemail system to retrieve a voicemail message, the recipient may be presented with location information relating to the voicemail message, thus providing location-aware voicemail. The location-aware voicemail message of the present subject matter may be one that includes both the data portion of a voicemail message and location data, which are combined in a manner, as described below, to create a location-aware voicemail message.

FIG. 1 illustrates an exemplary and non-limiting system for providing location-aware voicemail and highlights certain components that are found in the more complete system description described in FIG. 15. In FIG. 1, mobile device 10 is in communication with mobile switching center 14 through base station 12. The user of mobile device 10 may place a call to mobile device 22, which for simplicity of illustration is shown as being also in communication with mobile switching center 14 through base station 12. If mobile device 22 is unavailable to receive a call, the user of mobile device 10 may be provided with an option to leave an audio message by voicemail server 18. If the user of mobile device 10 decides to leave an audio message, according to an embodiment of the present subject matter, voicemail server 18 may determine one or more locations and affix the one or more locations to the audio message to generate voicemail message 24. The locations may include, but are not limited to, the location of mobile device 10 (the “caller's location”) or the location of mobile device 22 (the “intended recipient's location).

It will be appreciated by persons of skill in the art that although both mobile devices 10, 22 share the same base station 12 and mobile switching center 14 in the example of FIG. 1, in general the caller's and recipient's respective mobile devices may each connect with a telecommunications network in which the present subject matter is deployed through different base stations and/or mobile switching centers. Voicemail server 18 need not be local to one or the other of these mobile switching centers or, indeed, to any particular mobile switching center, but may be placed at any suitable location in the network. Multiple and/or distributed voicemail servers may be used in some embodiments. Further, it should be noted that the invention is not limited to mobile devices, but rather, either or both of a caller's location or the recipient's location could be landlines.

Voicemail server 18 may use various systems or processes in order to determine the one or more locations. For example, voicemail server 18 may be in communication with location server 20. Location server 20 may be configured to store the location of one or more mobile devices, such as mobile devices 10 and 22, using various methods as known by those skilled in the art. For example, the location may be determined using GPS or AGPS, TDOA, or other types of location determining systems. Additionally, HLR 16 or VLR 17 may be used to determine location of either mobile device 10 or mobile device 22, or alternatively, the location of base station 12 in communication with either mobile device 10 or mobile device 22 may be known and used as the location.

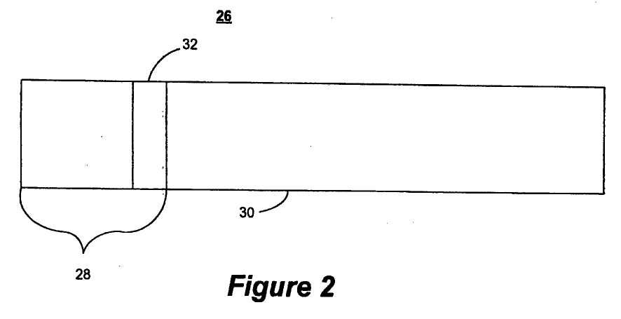

It is to be understood that a voicemail message described herein includes both elements of location-based data information in addition to data comprising a message, such as audio, video or text, left by a caller to be reviewed by an intended recipient of the voicemail message. For example, if a recipient of a voicemail message were to retrieve the voicemail message from a voicemail server, such as that described in FIG. 2, below, the voicemail message stored, retrieved, and transmitted would comprise location-based information and data comprising a message.

After a location is determined, the location information is affixed to the audio or other message left by the user of mobile device 10 to generate voicemail message 24 stored in voicemail server 18. FIG. 2 is an exemplary voicemail message data structure that may be used to implement the present subject matter in a packet based network. Voicemail message 26 is a data packet that may be transmitted to a recipient using a voicemail service. For purposes of clarity, only relevant segments of voicemail message 26 are shown, it being understood by those skilled in the art that additional segments of voicemail messages may be present.

Location-aware voicemail message 26 has header portion 28 which contains certain information, such as envelope information typically comprising caller's name, telephone number and time of call, recipient's identification and routing information. Voicemail message 26 may also have data portion 30 which may be an audio, video, or multimedia recording or other suitable digital content provided by the caller. Alternatively, data portion 30 may be derived from content provided by the caller, for example, where the caller provides textual input that is converted to an audio representation through text-to-speech software, or where the caller provides voice input that is converted to a textual representation through speech-to-text software. To provide location information, voicemail message 26 may also have location information affixed to header portion 28. In this exemplary embodiment illustrated in FIG. 2, location information 32 is affixed to voicemail message 26 and is contained in header portion 28. In other embodiments, voicemail message 26 may have location information 32 affixed to data portion 30, or otherwise associated with data portion 30 rather than with header portion 28, or combined with header portion 28 and/or data portion 30 in other ways.

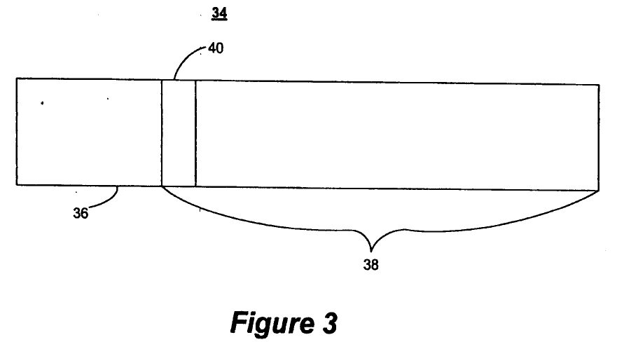

It should be understood that location information 32 may be affixed in other manners. For example, as will be described below with reference to FIGS. 3-5, location information 32 may be appended to one or more portions of voicemail message 26, prepended to one or more portions of voicemail message 26, interleaved with one or more portions of voicemail message 26, or embedded within with one or more portions of voicemail message 26 while maintaining one or more portions of voicemail message 26 distinct from location information 32. The affixed location information 32 is extracted for display or presentation on a device, the type of display or presentation may depend upon the type of data that is affixed. For example, graphical location information may be affixed to create a voicemail message. When extracted, the graphical location information may be presented graphically.

FIG. 3 illustrates one such alternative embodiment in which location information may be affixed to a data portion to create a voicemail message. Voicemail message 34 has header portion 36 and data portion 38. Data portion 38 may be an audio, video, or multimedia recording or other suitable digital content provided by a user of a voicemail service (or derived from content provided by the user, as previously described in reference to FIG. 2). Location information 40 is shown prepended to data portion 38.

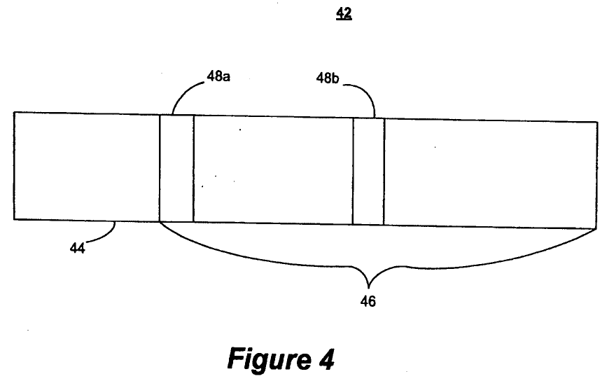

FIG. 4 is another alternative embodiment in which the voicemail message 42 includes interleaving the location information portions 48a, 48b into a voicemail message. Interleaving is a technique in which data is stored in a non-contiguous format for various reasons, such as improving performance. Voicemail message 42 has header portion 44 and data portion 46 (which, once again, may be any suitable digital content provided by a user or derived therefrom). Location information portions 48a and 48b, stored non-contiguously within data portion 46, when combined upon retrieval, constitute at least a portion of the location information determined.

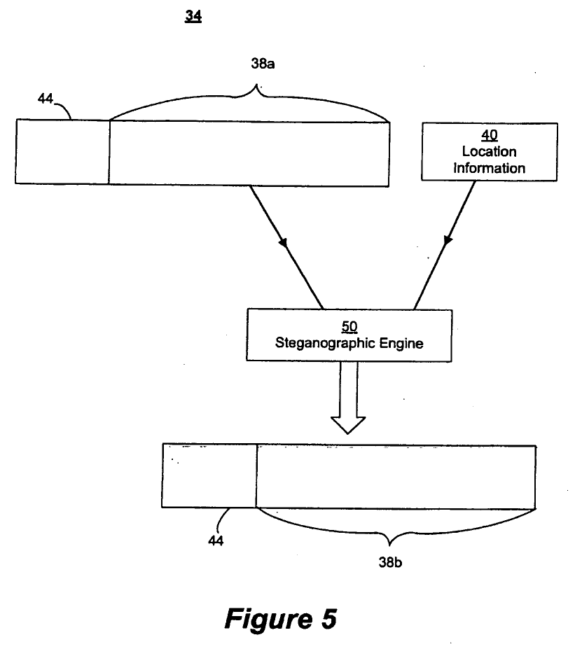

In yet another embodiment illustrated in FIG. 5, location information 40 may be embedded into one or more portions of voicemail message 34, such as data portion 38a so that the existence of data portion 38a remains apparent but the existence of location information 40 is concealed. This may be done, for example, if it is desired that the existence of location information 40 be kept unknown to unintended observers to avoid detection of the presence of location information 40. An exemplary way in which this may be done is through the use of a technique termed steganography. Examples of steganographic techniques may be found in a paper written by Jacokes, Kodysh and Lisy, entitled, “Audio Steganography”, dated Dec. 13, 2006, incorporated herein by reference. The authors describe ways in which information may be encoded into a waveform audio format (WAV) message.

In an exemplary use, location information 40 may be vital and sensitive information, but the communication system through which voicemail message 34 is being transmitted may be not be secure. It may be desired, or necessary, that even if voicemail message 34 is received by an unintended recipient, an unintended recipient may not realize that voicemail message 34 has location information 40 embedded therein. In one example, a steganographic engine, such as steganographic engine 50, may be used to embed location information 40 into one or more parts of voicemail message 34.

In the present example, voicemail message 34 has header portion 44 and data portion 38a. Data portion 38a may be an audio, video, or multimedia recording or other suitable digital content provided by a user of a voicemail service (or content derived therefrom). One or more systems may be used to generate location information 40. One or more portions of voicemail message 34 may be inputted into steganographic engine 50 along with location information 40. Steganographic engine 50 receives the inputted information and embeds location information 40 within the inputted information. In the voicemail message 34 of FIG. 5, location information 40 is embedded into data portion 38a to generate a new data portion, data portion 38b. Data portion 38b has location information 40 embedded within it, though by using steganographic techniques, data portion 38a and data portion 38b may be perceived by the user to be the same. For example, if data portion 38a is an audio recording, an audio playback of data portion 38a through the voicemail system (that is, a playback of the audio recording prior to the embedding therein of location information 40) may be indistinguishable to the listener from an audio playback through the voicemail system of data portion 38b (that is, a playback of the audio recording after the embedding therein of location information 40).

It should be understood that because various communication systems may use different data structures to transmit information, the data structures shown by example in FIGS. 2-5, and the accompanying description, are not intended to be limiting in scope. For example, the information may be transmitted using other communication protocols or schema, including user-defined structures such as XML or VXML.

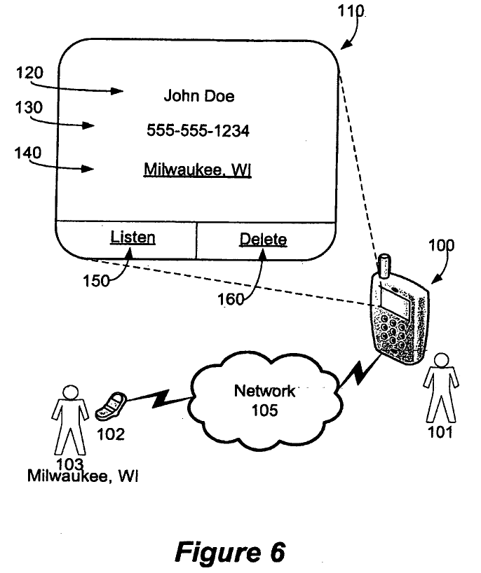

FIG. 6 illustrates an exemplary, non-limiting mobile device 100 on which one embodiment of the present disclosure may be displayed. Recipient 101 uses mobile device 100 to check a voicemail message from caller 103 who used caller mobile device 102 to leave an audio message. The call was connected through network 105. Network 105 may be any network capable of providing telecommunications and voicemail services, including, but not limited to, a cellular telephone network, a data network, the Internet, a public network, a private network, or any combination of these or any other type of network capable of providing telecommunications services. When caller 103 leaves an audio message, the location information of caller mobile device 102 is sent to a voicemail service, such as voicemail server 18 of FIG. 1, which would typically be a component within network 105 but not shown as such. When recipient 101 connects to a voicemail service to check for voicemail messages, recipient 101 is presented with display 110 on mobile device 100. Display 110 presents recipient 101 with the name 120, number 130, and geographical location 140 of caller 103.

In the present example shown in FIG. 6, when caller 103 left an audio message for recipient 101, the caller was located in Milwaukee, Wis. Although the location is shown to be a city and state, depending upon the capabilities of various components, such as network 105 or caller mobile device 102, the location may be presented in other formats, such as a street address or location relative to a landmark, such as a building. Recipient 101 may also be provided additional capabilities, such as the option to listen 150 to the audio portion of the voicemail message or delete 160 the voicemail message. The present subject matter is not limited to any particular type of options, as other options may be provided in conjunction with location-aware voicemail. Moreover, the present subject matter may use any one of a number of techniques for determining the location of caller 103.

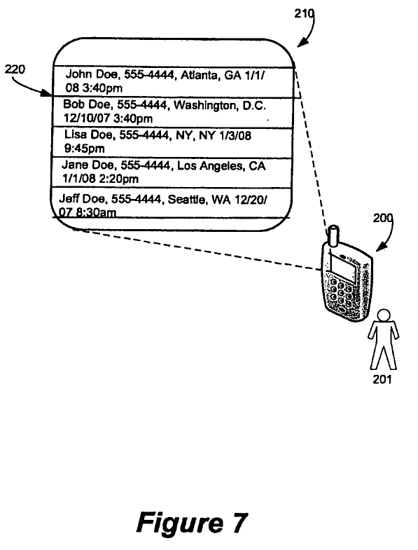

Because location information may be useful to the recipient of the voicemail message, a mobile device may be configured to display the voicemail message, along with other voicemail messages, in a manner that incorporates the location information into the display. In one example, the location information that is extracted from one or more received voicemail messages may be analyzed to determine a presentation order, hierarchy, priority, layout, format, mapping, or filtering for the voicemail messages. FIG. 7 illustrates an exemplary and non-limiting voicemail message display in which multiple voicemail messages are sorted based upon location. For example, recipient 201 of the voicemail message may set a filter on a voicemail service, such as voicemail server 18 of FIG. 1. The filter may configure display 210 of mobile device 200 to present voicemail messages in a list format, with voicemail messages received from a closest geographic location first and ending with the voicemail message furthest in distance from recipient 201. In a sort by distance mode as shown, the voicemail server 18 would also access the location server 20 to determine the location of the recipient 201.

If a filter is set, recipient 201, when checking for voicemail messages using mobile device 200, is presented with list 220. Shown, for example only, is information relating to five voicemail messages. The information shown includes, but is not limited to, the caller's name, the caller's telephone number, the date and time in which an audio portion of a voicemail message was left, and the city and state where the caller left the audio portion. As shown in list 220, the voicemail message information need not be presented in temporal order, i.e. the latest voicemail messages shown first. Instead, the voicemail message information may be sorted using the location, e.g. city and state, as the filter. For example, recipient 201 may be located in Atlanta, Ga., and thus, may want to see all voicemail messages from Atlanta, Ga. first with the remaining voicemail messages sorted according to their relative distance from Atlanta, Ga.

Although the filter described in regards to FIG. 7 uses location as the determinative variable, it should be understood that additional variables may be used, either in lieu of or in conjunction with location. For example, while recipient 201 may wish to view voicemail messages geographically closest to recipient 201, recipient 201 may also wish to view recently left voicemail messages first as well. Thus, a weighting factor may be used to sort and list the voicemail messages according to both location and time. For example, an equation may be used to determine the relative importance of a voicemail message. An exemplary equation, such as C=A*X+B*Y, may be applied to each voicemail message. “A” and “B” may be weighting factors and “X” and “Y” may be numerical representations of location and time, respectively. The voicemail messages may be presented with those having the greater sums shown higher on list 220 while those with lower sums shown lower on list 220. For example, “X” may be the distance in miles or kilometers as measured from the determined location to recipient 201. “Y” may be the difference in time between the time at which the audio portion of the voicemail message was left and the time at which recipient 201 receives the voicemail message.

To provide context to the sum of the distance and time measurements, weighting factors “A” and “B” may be used and modified. For example, if time is the more important determinative factor, then “B” may be increased to a value in which the product of “B” times “Y” controls the sum of the equation more than the product of “A” times “X”. In another example, if distance is the only determinative factor, weighting factor “B” may be set to zero. Additionally, the weighting factors may be changed, in one embodiment automatically or by a system or device, depending upon certain criteria, such as the time of day. It should be understood that other determinative factors may be used, such as the identity of the person leaving the audio portion of the voicemail message, or a numerical value associated with that person's identity (e.g., a higher value for a family member or work supervisor, a lower value for an unknown caller).

Another determinative factor may be whether or not the call may be an emergency call routed to a voicemail service. If a voicemail was sent in an emergency situation, it may be beneficial to display first the voicemail messages left by individuals in the area of the emergency.

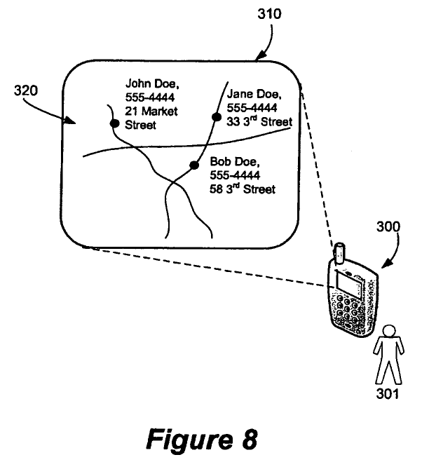

Although the prior examples have been discussed in terms of determining the location of the caller leaving the audio portion of the voicemail message, to implement the present subject matter, it may also be necessary or beneficial to determine the location of the recipient, either at the time the voicemail message was received or at the time the voicemail message is displayed or retrieved. The location information of the recipient along with the caller may be useful when used in conjunction with a mapping service to display voicemail message information. It should be understood that the information may be presented via a presentation capability of the device in various ways, such as audibly, textually, or graphically, or in other manners that constitute human-readable form. FIG. 8 illustrates such an embodiment, where location information of the caller and recipient are used to graphically display voicemail message information on a map.

When recipient 301 accesses mobile device 300 to check for voicemail messages, the recipient may be presented with a display such as display 310. As shown, display 310 shows a road map with three streets, two of which are Market and 3^{rd} Street. Recipient 301 may be at the corner of Market and 3^{rd} when checking for voicemail messages. Recipient 301 is then presented with map 320 having, for example only, three voicemail messages: John Doe, Jane Doe, and Bob Doe. The location of the caller when the voicemail messages were left is presented to recipient 301 as dots on map 320. For example, it is shown that Bob Doe was at “58 3^{rd} Street” when Bob Doe left a voicemail message. To listen to the audio portion of the voicemail message, recipient 301 may click on the dot corresponding to the location of Bob Doe or select the voicemail message in another manner.

Recipient 301 may use the information presented in FIG. 8 in various ways. For example, if recipient 301 is a company technician who is in transit, and the voicemail messages were left by customers of the company requesting service, recipient 301 may be able to more efficiently answer the service requests by attending those requests closest to his present location or close to other service calls. Additionally, recipient 301 may use the information presented in display 310 to verify the information contained in the voicemail message. For example, recipient 301 may be the father of “Jane Doe”. Jane Doe may have stated in her voicemail message that she is on her way home from school, but the location corresponding to her voicemail message may indicate that Jane Doe is not in the vicinity of the school. Thus, recipient 301 may query Jane Doe to determine why she is not at an expected location.

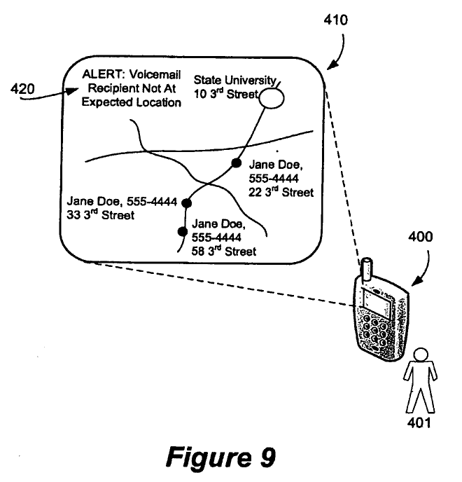

If a recipient of a voicemail message wishes to monitor the behavior of a caller based on a location, such as may be used in a managed voicemail account, the recipient may specify a location and request that the voicemail service display voicemail message information in relation to the specified location, as shown for example in FIG. 9. Recipient 401 may be an administrator of a voicemail service account for Jane Doe. For example, recipient 401 may be a parent, guardian, caretaker, or employer of Jane Doe and wish to monitor the behavior of Jane Doe using a voicemail service account. In the present example, recipient 401 sets, as a selected location, the university in which Jane Doe attends, shown as State University located at 103^{rd} Street.

Recipient 401 may have been out of contact with a mobile network and may have received multiple voicemail messages. Upon using mobile device 400 to check for voicemail messages, recipient 401 may be presented with display 410. Display 410 is a map showing three roads and three voicemail messages, all left by Jane Doe. Display 410 also shows alert 420, which informs recipient 401 that the voicemail messages left by Jane Doe are not associated with the selected location, shown as State University. Thus, recipient 401 may be alerted to an atypical, out of the ordinary or emergency situation before checking the voicemail messages.

Further, recipient 401 may be able to check the location information of the voicemail message against the location of the caller when the voicemail message was left to determine an emergency situation. For example, if Jane Doe was kidnapped, to keep the appearance that she is okay, she may be placed under duress by her kidnappers to leave voicemail messages stating that she is okay and is studying in her dorm room. As shown by the location of the caller when leaving the voicemail messages, it may be apparent that this is not the case.

The selected location may also be used as a filter, such as the filter discussed in reference to FIG. 7, above. For example, recipient 401 may be on vacation and wish only to receive voicemail messages from certain locations and to archive other voicemail messages. Recipient 401 may set as a filter State University, the expected location of Jane Doe. Multiple locations may be used as well. For example, recipient 401 may have multiple children in various colleges or schools, an aging parent in a nursing home, or may be required to receive calls from work. The location of each of these examples may be used as a selected location and/or a filter. Additionally, alert 420 may be used in conjunction with or in lieu of a mapping service. For example, list 220 shown in FIG. 7 may be altered to indicate an unexpected condition. For example, voicemail messages may be presented in one color to indicate an expected condition and another color to indicate an unexpected condition. An unexpected condition may be, for example, that a determined location is not the same as a selected location. The ability to set filters may be used in a managed voicemail account.

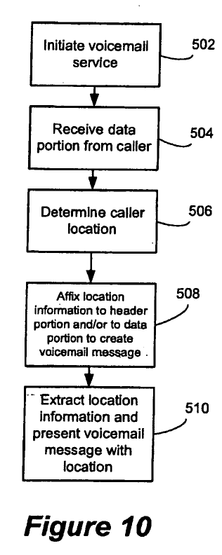

FIG. 10 is a flow diagram of a basic exemplary and non-limiting process for providing location-aware voicemail. After the voicemail service is initiated 502, the caller leaves 504 a data portion, such as an audio recording, of a voicemail message for an intended recipient. The caller's location is determined 506. The determined location is affixed 508 to a header portion (if present; the header portion is optional) and/or to the data portion to create at least a portion of a voicemail message, which is extracted from the voicemail message and presented 510 to the intended recipient. The determined location may be affixed in various manners, such as those described above, the present subject matter not being limited to any one manner.

As discussed above, the voicemail message may have a data portion, such as an audio recording, a header portion, as well as location information affixed to one or more portions of the voicemail message. If the location of the caller is determined, the location may be affixed to the voicemail message at the time the voicemail message is stored. Alternatively, the voicemail message may be transcribed, automatically or otherwise, and presented in text format, such as in an e-mail. The location of the caller may be included as text along with the transcribed voicemail message. Further, the location information that is extracted may be analyzed to determine a presentation order, a hierarchy, a priority, a layout, a format, a mapping, or filtering for the voicemail messages.

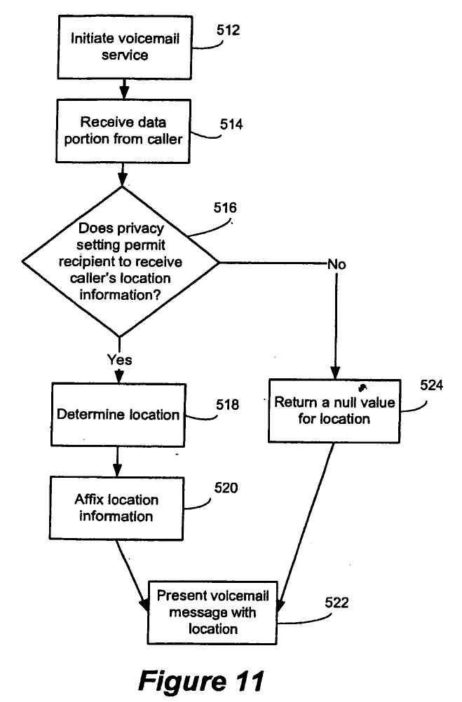

It should be understood that location information may not always be available or usable. For example, a caller may not wish to have his or her location displayed. In that situation, the caller may be able to use a privacy setting to block the determination of location information or the display of location information to the intended recipient of the voicemail message. FIG. 11 illustrates an exemplary and non-limiting process in which a privacy setting may be used to block the display of location information. After the voicemail service is initiated 512 and the data portion of a voicemail message is received 514, a query is generated 516 to determine if the recipient is permitted to view the caller's location. The permission may be determined based upon a privacy setting established by either the caller, the recipient, or a third entity, such as an employer or parent of either the caller or the recipient.

The privacy setting may be an “on” or “off” setting, i.e. either the recipient is allowed or not allowed to view caller location information. The privacy setting may also include an intermediate setting in which the recipient is allowed to view only limited location information. The intermediate setting may be useful if exact information is undesirable but general location information is needed. For example, a parent may only wish to know that their child is at school and may not care to know which building or classroom the child is in when leaving a voicemail message.

If the privacy setting is such that the recipient is not allowed to view the caller's location, the location may be returned 524 as a null value when the voicemail message is presented 522 to the recipient of the voicemail message. The privacy setting may also prevent the determination of a location. For example, a location of a police officer or other government official using a cellular phone may be sensitive information. The privacy setting may prevent the determination of the location to protect the individual. If the privacy setting is such that the recipient is allowed to view the caller's location, the location of the caller is determined 518. The location is affixed 520 and presented 522 to the recipient of the voicemail message.

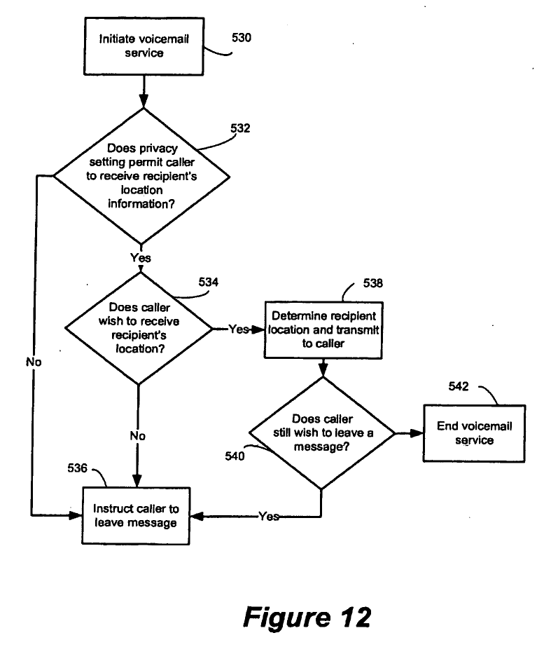

Although the prior examples have been discussed in terms of determining the location of the caller leaving the voicemail message, the same principles may be applied to determining the location of the intended recipient of the voicemail message. For example, a caller may not wish to leave a voicemail message for a recipient to go to dinner that night if the recipient is currently located in another state or country. FIG. 12 illustrates the use of recipient location information in a location-aware voicemail system. After the voicemail service is initiated 530, a determination 532 is made as to whether or not the caller is permitted to receive the recipient's location. It should be understood that this determination may be made by using controls such as privacy settings or, alternatively, may not be performed at all.

If the caller is not allowed to receive location information about the recipient, the caller may be prompted 536 to leave a voicemail message on the voicemail server, such as voicemail server 18 of FIG. 1. If the caller is allowed to receive location information about the recipient, the caller may be queried 534 as to whether or not the caller desires to receive location information. If the caller does not wish to receive location information, the caller may be prompted 536 to leave a voicemail message. If the caller does desire to receive location information, the recipient's location 538 is determined and transmitted to the caller. After the location information is transmitted to the caller, the caller may be queried 540 as to whether or not the caller still wishes to leave a voicemail message. If the caller wishes to leave a voicemail message, the caller may be prompted 536 to leave a voicemail message. If the caller does not wish to leave a voicemail message, the caller may just hang up and end 542 the voicemail service. In accordance with an exemplary embodiment of the present subject matter, the caller may receive location information prior to the affixing of the data portion of message with the location data portion of the message.

It should be understood that one or all of the queries may or may not be used. The queries are for exemplary purposes only and are not intended to limit the scope of the present subject matter to the use of the queries. For example, after the voicemail service is initiated at block 530, the location of the recipient may be automatically provided and the caller may be automatically prompted to leave a voicemail message. The use of the queries may assist the caller in determining whether or not to leave a voicemail message based upon the location of the recipient, if the caller is even allowed to receive the location information of the caller.

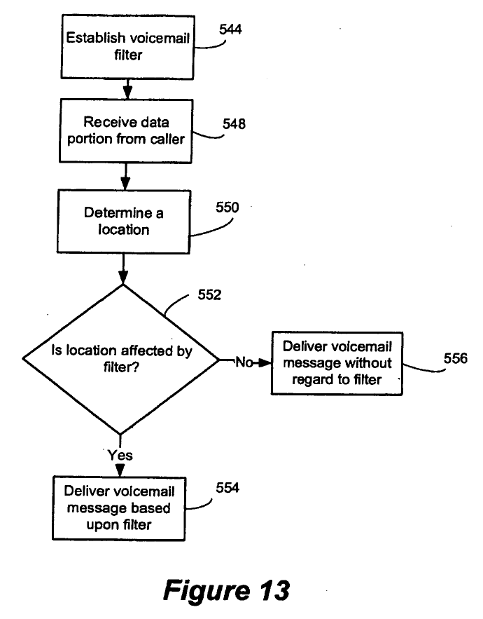

To assist the recipient in organizing their voicemail messages using a voicemail service, as discussed in FIG. 6 above, filters may be used to sort voicemail messages. FIG. 13 illustrates the use of a filter to sort voicemail messages using location as the determinative variable. A voicemail message filter is first established 544. The filter may be established by various entities, including the user of the voicemail service or an administrator of the voicemail service. For example, a user of location-aware voicemail may have a child. The parent may set a filter on the parent's phone so that any voicemail message left by any caller in the location of the child's school will be listed first in a list of voicemail messages. In another example, an employee of a company may have an important account at a business located in a certain place. The employee, or the company if the company is an administrator of the voicemail account, may set a filter so that any voicemail message that originates from the location of the business is listed first. This may be useful because the employee or employer may not know all the telephone numbers of the account.

Continuing with FIG. 13, after the voicemail filter is set, a data portion, e.g. audio recording, is received 548 from a caller. A location is determined 550 and a query is made as to whether the location is affected by the filter. For example, an employer may want to filter voicemail messages from any location other than the location(s) of the business account. Thus, if the location is determined to be something other than the location(s) of the account, the filter may not be applicable. If the filter is not applicable, the voicemail message may be presented 556 without regards to the filter. If the filter is applicable, the voicemail message is delivered 554 based upon the filter.

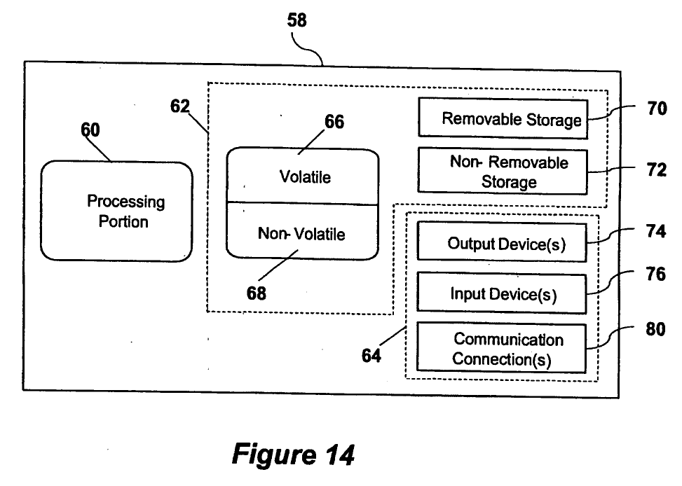

FIG. 14 is a block diagram of an example processor 58 for generating and/or determining and transmitting and/or receiving geographical location information used in a location-aware voicemail service. Such a processor also may be used for affixing location information to the header portion and/or data portion of a voicemail message. In an example configuration, the processor 58 may be one component of caller mobile device 102, recipient mobile device 100, or a combination thereof. It is emphasized that the block diagram depicted in FIG. 14 is exemplary and not intended to imply a specific implementation. Thus, the processor 58 can be implemented in a single processor or multiple processors. Multiple processors can be distributed or centrally located. Multiple processors can communicate in a wireless or wired communication system, or a combination thereof.

The processor 58 comprises a processing portion 60, a memory portion 62, and an input/output portion 64. The processing portion 60, memory portion 62, and input/output portion 64 are coupled together (coupling not shown in FIG. 14) to allow communications there between. The input/output portion 64 is capable of providing and/or receiving components utilized to determine or generate location information and transmit or receive such information as described above. For example, the input/output portion 64 is capable of providing/receiving geographical location information, determining the privacy level of a recipient, transmitting/receiving geographical location information, processing requests for additional information based upon the geographical location information, executing programs and applications based upon the geographical location information, formatting voicemail messages (e.g., using one or more of the formats illustrated in FIGS. 2-5 above), or any combination thereof, as described above.

The processor 58 can be implemented as a client processor and/or a server processor. In a basic configuration, the processor 58 can include processing portion 60 and memory portion 62. The memory portion 62 can store any information utilized in conjunction with generating/determining and/or receiving/transmitting geographical location information. For example, as described above, the memory portion is capable of storing one or more lists of recipients, one or more privacy levels, applications and software to generate or retrieve information related to a geographical location, or any combination thereof. Depending upon the exact configuration and type of processor, the memory portion 62 can be volatile (such as RAM) 66, non-volatile (such as ROM, flash memory, etc.) 68, or a combination thereof. The processor 58 can have additional features/functionality. For example, the processor 58 can include additional storage (removable storage 70 and/or non-removable storage 72) including, but not limited to, magnetic or optical disks, tape, flash, smart cards or a combination thereof. Computer storage media, such as memory portion 62, 70, 72, 66, and 68, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 58. Any such computer storage media can be part of the processor 58.

The processor 58 can also contain the communications connection(s) 80 that allow the processor 58 to communicate with other devices, for example through network 105. Communications connection(s) 80 may be an example of communication media. Communication media may be used to transmit information contained in computer readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media may include wired media such as a wired network or direct-wired connection as might be used with a land-line telephone, and wireless media such as acoustic, RF, infrared, cellular, and other wireless media. The term computer readable storage medium, as may be used herein, may include both storage media and communication media. The processor 58 also can have input device(s) 76 such as keyboard, keypad, mouse, pen, voice input device, touch input device, etc. Output device(s) 74 such as a display, speakers, printer, etc. also can be included.

The following description sets forth some exemplary telephony radio networks and non-limiting operating environments in which geographical location information can be implemented in a location-aware voicemail system. The below-described operating environments should be considered non-exhaustive, however, and thus the below-described network architectures merely show how geographical location information can be incorporated into existing network structures and architectures. It should be appreciated that geographical location information can be incorporated into existing and/or future alternative architectures for communication networks as well.

The global system for mobile communication (“GSM”) is one of the most widely utilized wireless access systems in today's fast growing communication environment. The GSM provides circuit-switched data services to subscribers, such as mobile telephone or computer users. The General Packet Radio Service (“GPRS”), which is an extension to GSM technology, introduces packet switching to GSM networks. The GPRS uses a packet-based wireless communication technology to transfer high and low speed data and signaling in an efficient manner. The GPRS attempts to optimize the use of network and radio resources, thus enabling the cost effective and efficient use of GSM network resources for packet mode applications.

As one of ordinary skill in the art can appreciate, the exemplary GSM/GPRS environment and services described herein also can be used with other services, such as Universal Mobile Telephone System (“UMTS”), Frequency Division Duplexing (“FDD”) and Time Division Duplexing (“TDD”), High Speed Packet Data Access (“HSPDA”), cdma2000 1x Evolution Data Optimized (“EVDO”), Code Division Multiple Access-2000 (“cdma2000”), Time Division Synchronous Code Division Multiple Access (“TD-SCDMA”), Wideband Code Division Multiple Access (“WCDMA”), Enhanced Data GSM Environment (“EDGE”), International Mobile Telecommunications-2000 (“IMT-2000”), Digital Enhanced Cordless Telecommunications (“DECT”), etc., as well as to other network services that become available in time. In this regard, the techniques of the disclosed subject matter can be applied independently of the method for data transport, and do not depend on any particular network architecture, or underlying protocols.

FIG. 15 illustrates an exemplary architecture of a GPRS network that may be configured to provide location-aware voicemail. The exemplary GPRS network is illustrated as comprising four groups: users 750, radio access network 760, core network 770, and interconnect network 780. Users 750 comprise a plurality of end users (though only mobile subscriber 755 is shown in FIG. 15). Radio access network 760 comprises a plurality of base station subsystems such as BSSs 762, which include BTSs 764 and BSCs 766. Core network 770 comprises a host of various network elements. As illustrated, core network 770 may comprise Mobile Switching Center (“MSC”) 771, Service Control Point (“SCP”) 772, gateway MSC 773, SGSN 776, Home Location Register (“HLR”) 774, Authentication Center (“AuC”) 775, Domain Name Server (“DNS”) 777, and GGSN 778. Interconnect network 780 also comprises a host of various networks and other network elements. As illustrated in FIG. 15, interconnect network 780 comprises Public Switched Telephone Network (“PSTN”) 782, Fixed-End System (“FES”) or Internet 784, firewall 788, and Corporate Network 789.

A mobile switching center can be connected to a large number of base station controllers. At MSC 771, for instance, depending on the type of traffic, the traffic may be separated in that voice may be sent to Public Switched Telephone Network (“PSTN”) 782 through Gateway MSC (“GMSC”) 773, and/or data may be sent to SGSN 776, which then sends the data traffic to GGSN 778 for further forwarding.

When MSC 771 receives call traffic, for example, from BSC 766, it sends a query to a database hosted by SCP 772. The SCP 772 processes the request and issues a response to MSC 771 so that it may continue call processing as appropriate.

The HLR 774 is a centralized database for users to register to the GPRS network. HLR 774 stores static information about the subscribers such as the International Mobile Subscriber Identity (“IMSI”), subscribed services, and a key for authenticating the subscriber. HLR 774 also stores dynamic subscriber information such as the current location of the mobile subscriber. Associated with HLR 774 is AuC 775. AuC 775 is a database that contains the algorithms for authenticating subscribers and includes the associated keys for encryption to safeguard the user input for authentication.

In the following, depending on context, the term “mobile subscriber” sometimes refers to the end user and sometimes to the actual portable device used by an end user of the mobile cellular service. When a mobile subscriber turns on his or her mobile device, the mobile device goes through an attach process by which the mobile device attaches to an SGSN of the GPRS network. In FIG. 15, when mobile subscriber 755 initiates the attach process by turning on the network capabilities of the mobile device, an attach request is sent by mobile subscriber 755 to SGSN 776. The SGSN 776 queries another SGSN, to which mobile subscriber 755 was attached before, for the identity of mobile subscriber 755. Upon receiving the identity of mobile subscriber 755 from the other SGSN, SGSN 776 requests more information from mobile subscriber 755. This information is used to authenticate mobile subscriber 755 to SGSN 776 by HLR 774. Once verified, SGSN 776 sends a location update to HLR 774 indicating the change of location to a new SGSN, in this case SGSN 776. HLR 774 notifies the old SGSN, to which mobile subscriber 755 was attached before, to cancel the location process for mobile subscriber 755. HLR 774 then notifies SGSN 776 that the location update has been performed. At this time, SGSN 776 sends an Attach Accept message to mobile subscriber 755, which in turn sends an Attach Complete message to SGSN 776.

After attaching itself with the network, mobile subscriber 755 then goes through the authentication process. In the authentication process, SGSN 776 sends the authentication information to HLR 774, which sends information back to SGSN 776 based on the user profile that was part of the user's initial setup. The SGSN 776 then sends a request for authentication and ciphering to mobile subscriber 755. The mobile subscriber 755 uses an algorithm to send the user identification (ID) and password to SGSN 776. The SGSN 776 uses the same algorithm and compares the result. If a match occurs, SGSN 776 authenticates mobile subscriber 755.

Next, the mobile subscriber 755 establishes a user session with the destination network, corporate network 789, by going through a Packet Data Protocol (“PDP”) activation process. Briefly, in the process, mobile subscriber 755 requests access to the Access Point Name (“APN”), for example, att.com (e.g., which can be FES or Internet 789 in FIG. 15) and SGSN 776 receives the activation request from mobile subscriber 755. SGSN 776 then initiates a Domain Name Service (“DNS”) query to learn which GGSN node has access to the att.com APN. The DNS query is sent to the DNS server within the core network 770, such as DNS 777, which is provisioned to map to one or more GGSN nodes in the core network 770. Based on the APN, the mapped GGSN 778 can access the corporate network 789. The SGSN 776 then sends to GGSN 778 a Create Packet Data Protocol (“PDP”) Context Request message that contains necessary information. The GGSN 778 sends a Create PDP Context Response message to SGSN 776, which then sends an Activate PDP Context Accept message to mobile subscriber 755.

To provide for location-aware voicemail services, the GPRS network of FIG. 15 may also have voicemail server 790 and location server 792. Voicemail server 790 and location server 792 may act in a manner similar to voicemail server 18 and location server 20 as described in FIG. 1, above. If a call placed by mobile subscriber 755 is not connected to a receiving subscriber, the call may be routed to voicemail server 790. Voicemail server 790 may prompt mobile subscriber 755 to leave a data portion, e.g. audio recording, of a voicemail message for the intended recipient of the call. Either in conjunction with the prompt, or after a voicemail message is left by mobile subscriber 755, voicemail server 790 may cause location server 792 to determine one or more locations. Voicemail server 790 may then affix the one or more locations to the voicemail message and store in voicemail server 790. (It will be appreciated that, as with voicemail server 18 in FIG. 1, the voicemail server 790 of FIG. 15 need not be local to the caller's MSC 771 or to any particular MSC, but may be situated at any appropriate point within, or in communication with, core network 770, and further that there may be multiple and/or distributed voicemail servers 790.)

While example embodiments of the disclosed subject matter have been described in connection with various computing devices, the underlying concepts can be applied to any computing device or system capable of implementing the disclosed subject matter. The various techniques described herein can be implemented in connection with hardware or software or, where appropriate, with a combination of both. Thus, the methods and apparatus for generating, transmitting, receiving, and/or implementing geographical location information within a location-aware voicemail service, or certain aspects or portions thereof, can take the form of program code (i.e., instructions) embodied in tangible media, such as floppy diskettes, CD-ROMs, DVDs, hard drives, or any other machine-readable storage medium, wherein, when the program code is loaded into and executed by a machine, such as a computer, the machine becomes an apparatus for implementing the disclosed subject matter. In the case of program code execution on programmable computers, the computing device will generally include a processor, a storage medium readable by the processor (including volatile and non-volatile memory and/or storage elements), at least one input device, and at least one output device. The program(s) can be implemented in assembly or machine language, if desired. In any case, the language can be a compiled or interpreted language, and combined with hardware implementations.

The methods and apparatus for geographical location information implemented within a location-aware voicemail service also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like, the machine becomes an apparatus for implementing the disclosed subject matter. When implemented on a general-purpose processor, the program code combines with the processor to provide a unique apparatus that operates to invoke the functionality of the disclosed subject matter. Additionally, any storage techniques used in connection with the disclosed subject matter can invariably be a combination of hardware and software.

While location-aware voicemail service has been described in connection with the various embodiments of the various figures, it is to be understood that other similar embodiments can be used or modifications and additions can be made to the described embodiment for performing the same function of providing the disclosed subject matter without deviating therefrom. For example, one skilled in the art will recognize that a system for implementing location-aware voicemail service using geographical location information as described may apply to any environment, whether wired or wireless, and may be applied to any number of devices connected via a communications network and interacting across the network. Therefore, location-aware voicemail service using geographical location information should not be limited to any single embodiment, but rather should be construed in breadth and scope in accordance with the appended claims.

What is claimed is:

1. A voicemail system comprising:
a voicemail server configured to receive a data portion of a message; and
a location server containing location data in communication with the voicemail server;
wherein the voicemail system is configured to create a location-aware voicemail message that combines both the data portion of the message and the location data wherein the location data is affixed to the data portion.

2. The system of claim 1, wherein the location data is a location of a calling party or a location of an intended recipient, or both.

3. The system of claim 2, wherein the calling party is provided the location of the intended recipient.

4. The system of claim 2, wherein the intended recipient sets a filter to determine a method for presenting the location-aware voicemail message.

5. The system of claim 4, wherein the method of presenting is one of a group comprised of: an audio playback; text; and a graphical display.

6. The system of claim 1, wherein the data portion is an audio recording or a text derived from the audio recording, or both.

7. The system of claim 1, wherein the location data of the voicemail message is combined with the data portion in at least one of the following ways: prepended; appended; interleaved; and embedded with the data portion.

8. The system of claim 1, wherein the voicemail server also records a header for the message, wherein the location data is combined with the header.

9. The system of claim 1, wherein the location data is designated as private.

10. The system of claim 1, wherein the voicemail system is further configured to provide a calling party with an option of receiving the location of an intended recipient prior to the location data being affixed to the data portion.

11. A method for creating a location-aware voicemail message, comprising:
determining a location;
receiving a data portion comprising a message; and
combining the location and a data portion to create the location-aware voicemail message.

12. The method of claim 11, wherein the location data is a location of a calling party or a location of an intended recipient of the data portion, or both.

13. The method of claim 11, where the data portion is an audio recording or a text derived from the audio recording, or both.

14. The method of claim 11, wherein the combining step includes one of: prepending; appending; embedding; and interleaving the location data with the data portion.

15. The method of claim 11, further comprising recording a header for the voicemail message, wherein the location is combined with the header.

16. The method of claim 11, further comprising:
sending the location to a calling party prior to combining the location and the data portion; and
receiving an input that the calling party will provide the data portion.

17. A method for accessing a location-aware voicemail message, comprising:
receiving, at a communications device, the location-aware voicemail message that comprises location information;
extracting location information from the received location-aware voicemail message; and
presenting the extracted location information.

18. The method of claim 17, wherein presenting the extracted location information comprises presenting the extracted location information audibly, textually, or graphically at the device to a user of the device via a presentation capability of the device.

19. The method of claim 18, wherein displaying the extracted location information comprises displaying a map including a location corresponding to the extracted location information.

20. The method of claim 17, wherein the receiving of the location-aware voicemail message comprises receiving, at the communications device, a plurality of a location-aware voicemail messages, each comprising respective location information.

21. The method of claim 20, wherein presenting the extracted location information comprises presenting to a user a presentation that combines location information extracted from each of two or more of the plurality of received location-aware voicemail messages.

22. The method of claim 21, further comprising:
analyzing location information extracted from each of two or more of the plurality of received location-aware voicemail messages to determine a presentation order, hierarchy, priority, layout, format, mapping, or filtering for the location-aware voicemail messages; and
wherein presenting the extracted location information comprises presenting to a user a presentation that combines location information extracted from each of two or more of the plurality of received location-aware voicemail messages according to the determined order, hierarchy, priority, layout, format, mapping, or filtering.

23. The method of claim 22, wherein presenting a presentation to the user comprises:
displaying a map on the communications device, the map including a plurality of locations each corresponding to location information extracted from the location-aware voicemail message of the plurality of received location-aware voicemail messages.

24. The method of claim 22, wherein analyzing extracted location information comprises:
determining a presentation order; and
displaying a list of voicemail messages in the determined order.

25. A computer-readable storage medium having instructions stored thereon which, when loaded onto a computer, cause the computer to perform the method of claim 16.

26. An apparatus for accessing a location-aware voicemail message, comprising:
a transceiver or receiver, configured to receive the location-aware voicemail message;
a processor configured to:
extract location information from the location-aware voicemail message, wherein the location-aware voicemail message comprises the location information; and
present the location information from the location-aware voicemail message on the apparatus; and
a memory configured to:
store the voicemail message;
store instructions of a computer-readable program, the instructions comprising:
communicate with a location-aware voicemail system;
receive the location-aware voicemail message, wherein the location-aware voicemail message comprises location information;
extract the location information from the location-aware voicemail message;
provide access to the location information; and
present the location information.

27. The apparatus of claim 26, wherein the apparatus is a mobile device.

28. The apparatus of claim 27, wherein the mobile device is a cellular telephone.

29. The apparatus of claim 26, wherein the location information is presented in at least one of the following forms: audibly; textually; and graphically.

30. The apparatus of claim 26, wherein the processor is further configured to control the presenting of the location information through the use of a filter.

31. The apparatus of claim 30, wherein the filter is further configured to mark as private a location of a user.

32. A voicemail server comprising:
a subsystem that interfaces with a location server, the subsystem configured to:
send a request to the location server;
receive a location;
capture a data portion of a message; and
combine the data portion with the location to form a location-aware voicemail message.

33. The voicemail server of claim 32, wherein the location is at least one of a group comprised of: a location of a calling party; and a location of an intended recipient of the data portion.

34. The voicemail server of claim 32, wherein the subsystem combines the data portion with the location in at least one of the following ways: appending; prepending; embedding; and interleaving the location with the data portion.

35. The voicemail server of claim 32, wherein the subsystem is further configured to generate a header, wherein the location is combined with the header.
